(19) United States
(12) Patent Application Publication
(10) Pub. No.: US 2018/0346797 A1
(43) Pub. Date: Dec. 6, 2018

(54) Coated Silica Particles

(71) Applicant: Saudi Arabian Oil Company, Dhahran (SA)

(72) Inventors: Rajendra Arunkumar Kalgaonkar, Abqaiq (SA); Fakuen Frank Chang, Dhahran (SA)

(73) Assignee: Saudi Arabian Oil Company, Dhahran (SA)

(21) Appl. No.: 15/994,733

(22) Filed: May 31, 2018

Related U.S. Application Data
(60) Provisional application No. 62/514,314, filed on Jun. 2, 2017.

(51) Int. Cl. C09K 8/57; C09K 8/575

(52) U.S. Cl. CPC C09K 8/572; C09K 2208/10; C09K 8/5755

(57) ABSTRACT

The present application relates to coated silica particles, compositions containing the coated silica particles, and methods for using these compositions in subterranean formations. The coated silica particle includes a cationic species non-covalently bound to an outer surface of the particle. The particle can include a nanoparticle.

### CLAIM OF PRIORITY

This application claims the benefit of U.S. Provisional Application No. 62/514,314, filed Jun. 2, 2017. The entire contents of the foregoing are hereby incorporated by reference.

### TECHNICAL FIELD

The present application relates to coated silica particles, compositions containing the coated silica particles, and methods for using these compositions in subterranean formations.

### BACKGROUND

Recoverable fluids, such as hydrocarbons (for example, petroleum or natural gas) and water, are frequently found in subterranean formations. Some subterranean formations are not sufficiently competent to prevent erosion of the formation by the flow of the fluid through the formation. Such formations, often referred to as unconsolidated or incompetent formations, contain uncemented or loosely consolidated grains of sand, clay or rock (for example, sandstone, limestone, quartz, zeolites, siltstone, shale or gravel). When the fluid flows through the formation, the loose materials, in particular, grains of sand, move along with the fluid causing erosion and disintegration of the formation. The loose sand can accumulate in the formation, in a wellbore, and within drilling equipment. Such an accumulation can cause clogging and reduced flow of the recoverable fluid. These entrained particles of sand can cause erosion of the underground equipment (for example, strainers, liners, valves and pumps), reduce pressure and restrict flow of the fluid, and contaminate the field storage tanks. Loose sand can be carried away by fluid flow to the surface and removed from the wellbore with a withdrawn fluid. If a sufficient amount of the sand is carried away from the producing formation, the formation may collapse causing significant damage to the well. Therefore, issues associated with the production of recoverable fluids from incompetent subterranean formations can reduce well productivity and increase well maintenance costs.

### SUMMARY

The present application discloses, inter alia, a method of sand control in unconsolidated formations. The methods described later in this document involve using positively charged modified particles of silica that can assemble over sand particles of the unconsolidated formation. The positively charged modified particles form a monolayer of consolidating material across the unconsolidated formation to provide sand control with desired permeability characteristics. The sand control treatment material of the present application includes colloidal silica particles modified using, for example, a cationic polymer and, optionally, a pH modifier or an ionic strength modifier that are placed downhole as a pill. The entire treatment can be placed downhole in single step operation. This modified silicate material forms a thin monolayer of a hard gel around the unconsolidated sand particles. The monolayer cements the sand grains together and at the same time ensures a retained permeability through the treatment material to facilitate production of hydrocarbons, such as petroleum.

In some aspects, a coated silica particle includes a cationic species non-covalently bound to an outer surface of the particle. The particle can include a nanoparticle. In some embodiments, the nanoparticle includes a diameter from about 1 nanometer (nm) to about 500 nm, a diameter from about 1 nm to about 150 nm, a diameter from about 5 nm to about 50 nm, or a diameter from about 5 nm to about 17 nm.

In some embodiments, the cationic species includes a metal cation. In some embodiments, the metal cation includes an oxidation state of 2 or greater. In some embodiments, the metal cation can include aluminum or iron. The metal cation can form a salt or an oxide selected from the group consisting of Al₂O₃, Al₂(SO₄)₃, KAl(SO₄)₂, FeCl₃ and Fe₂(SO₄)₃, and a hydrate or a solvate thereof.

In some embodiments, the cationic species includes a cationic polymer. The cationic polymer can be selected from the group consisting of poly(2-hydroxypropyl-1-N-dimethylammonium chloride), poly(2-hydroxypropyl-1-1-N-dimethylammoniumchloride), poly[N-(dimethylaminomethyl)]-acrylamide, poly(2-vinylimidazolinium bisulfate), poly(diallyldimethylammoniumchloride), poly(N-dimethylaminopropyl)-methacrylamide, and combinations thereof. In some embodiments, the cationic polymer includes poly(diallyldimethylammoniumchloride). In some embodiments, the molecular weight of the cationic polymer ranges from about 1,000 Daltons (Da) to about 1,000,000 Da, from about 1,500 Da to about 500,000 Da, or from about 1,500 Da to about 100,000 Da.

In some embodiments, the cationic polymer can be water soluble.

In some embodiments, the cationic species can include a quaternary ammonium compound. In some embodiments, the quaternary ammonium compound can contain 1,2-ethanediaminium, N,N′-bis[2-[bis(2-hydroxyethyl)methylammonio]ethyl]-N,N′-bis(2-hydroxyethyl)-N,N′-dimethyl-, tetrachloride.

In some embodiments, an amount of the cationic species relative to the weight of the silica particle ranges from about 5 weight % (wt. %) to about 20 wt. %. The coated particle can include a net positive charge. The non-covalent binding between the cationic species and the outer surface of the silica particle can include an electrostatic interaction. In some embodiments, the electrostatic interaction can include attraction between the negatively charged outer surface of the silica particle and the positively charged cationic species. In some embodiments, the electrostatic interaction can include attraction between silanol groups or silyloxy anions on the outer surface of the silica particle and the positively charged cationic species.

In some aspects, a method of making a coated silica particle containing a cationic species non-covalently bound to an outer surface of the silica particle includes: (i) obtaining a colloid dispersion comprising a solid silica particle in a dispersed phase and a solvent in a continuous phase; (ii) obtaining a cationic species; and (iii) combining the colloid dispersion of step (i) with the cationic species of step (ii) to obtain a coated silica particle. In some embodiments, the solid silica particle can be a nanoparticle. The nanoparticle can include a diameter from about 1 nm to about 500 nm, a diameter from about 1 nm to about 150 nm, a diameter from about 5 nm to about 50 nm, or a diameter from about 5 nm to about 17 nm.

In some embodiments, the solvent in the continuous phase of the colloid dispersion comprises water. An amount of the dispersed phase in the colloid dispersion can range from about 5 wt. % to about 50 wt. %, or an amount of the dispersed phase in the colloid dispersion can be about 15 wt. %.

In some embodiments, the method described in this document include adding a solution of an inorganic salt to the colloid dispersion. The inorganic salt can contain NaCl. A concentration of the inorganic salt in the solution can range from about 1% weight/volume (w/v) to about 30% w/v. An amount of the solution of an inorganic salt can range from about 5 wt. % to about 15 wt. % relative to the amount of the colloidal dispersion.

In some embodiments, the method described in this document can include the cationic species in a form of a solution. The solution can include an aqueous solution. A concentration of the cationic species in the solution ranges from about 10 wt. % to about 50 wt. %. An amount of the cationic species can range from about 0.1 wt. % to about 2 wt. % relative to an amount of the colloidal dispersion.

In some embodiments, the combining step can include adding the cationic species to the colloid dispersion. The combining can be followed by continuously stirring the reaction mixture for an amount of time sufficient to obtain the coated silica particle. The amount of time can range from about 1 minute to about 15 minutes. In some embodiments, the combining step can include a non-covalent binding of the cationic species to the outer surface of the silica particle.

In some aspects, a coated silica particle is prepared by any one of the methods described in this document.

In some aspects, a hardenable delayed-gelling composition includes a particulate material comprising the coated silica particle described earlier in this document. The amount of the particulate material in the composition can range from about 10 wt. % to about 50 wt. %, or an amount of the particulate material in the composition can be about 15 wt. %. The composition can include a solvent. The solvent can include water. The composition can include from about 50 wt. % to about 90 wt. % water. A pH of the composition can range from about 9 to about 11. A viscosity of the composition can range from about 5 centipoise (cP) to about 10 cP.

In some embodiments, the composition can contain an activating agent. The activating agent can include a pH modifier. The pH modifier can contain an ester compound. The ester compound can be selected from the group consisting of a formate ester, a lactate ester, and a polylactide resin. The ester compound can be selected from the group consisting of diethylene glycol diformate and ethyl lactate. The ester compound can hydrolyze to produce an acid compound. The hydrolysis of the ester compound can occur at a temperature ranging from about 75° F. to about 350° F. The hydrolysis of the ester compound can occur at a temperature ranging from about 150° F. to about 250° F. The hydrolysis of the ester compound can result in reduction of a pH of the composition to less than about 5. The amount of the pH modifier in the composition can range from about 0.25 wt. % to about 4 wt. %.

In some embodiments, the composition can include an ionic strength modifier. The ionic strength modifier can contain an inorganic electrolyte. The inorganic electrolyte can be selected from the group consisting of KCl, NaCl and NaBr. An amount of the ionic strength modifier in the composition can range from about 1 wt. % to about 5 wt. %. The activating agent can be configured to facilitate hardening of the composition. The composition can be adapted to form a hard consolidated gel three hours or more after formation of the composition. The composition can be adapted to form a hard consolidated gel at a temperature ranging from about 75° F. to about 350° F. The composition can be adapted to form a hard consolidated gel at a temperature ranging from about 150° F. to about 250° F. In some embodiments, the composition is considered a hard consolidated gel when it is unable to flow.

In some aspects, a method of consolidating an incompetent subterranean formation includes contacting an incompetent formation with a hardenable delayed-gelling composition of any one of the compositions described in this document to obtain a consolidated mass of subterranean particles. The contacting can further comprise absorbing the hardenable delayed-gelling composition on a surface of unconsolidated subterranean particles. The hardening of the composition can comprise cementing the subterranean particles as a layer of hard gel on the unconsolidated subterranean particles. The subterranean particles can comprise sand grains. The consolidated mass of subterranean particles can be permeable to fluids. The consolidated mass of subterranean particles can have a strength to hold a pressure load of about 700 pound-force (lbf) or greater. The consolidated mass of subterranean particles can have strength to hold a pressure load from about 700 lbf to about 1000 lbf. The incompetent subterranean formation can be penetrated by a wellbore. The contacting can comprise delivering the hardenable delayed-gelling composition to the incompetent subterranean formation using a coil tubing equipment. The incompetent subterranean formation can comprise a hydrocarbon-bearing formation. The hydrocarbon can comprise petroleum. The method can further comprise producing petroleum from the consolidated formation.

Certain embodiments of the compositions described in this document are designed to consolidate loose sand particles of an unconsolidated formation. The concentration ranges and ratios of different ingredients (for example, additives) described in this document can be useful in mitigating unwanted sand production encountered during petroleum production.

In some embodiments, the compositions described in this document contain coated nanosilica particles that respond in the presence of specific disclosed chemical activators. For example, the compositions can include coated nanosilica particles, where the viscosity of the coated nanosilica particles increase and eventually gel in response to the specific chemical activators. In some embodiments, this gelling response described above may occur under static conditions as well as under dynamic conditions. In various embodiments, the gelling response can be independent of shearing conditions, temperature conditions, or both. For example, in the absence of the disclosed chemical activators, certain embodiments of the coated nanoparticles will not gel under conditions in which the nanoparticles are sheared, exposed to high temperatures, or a combination of both. Thus, in some embodiments, the gelling characteristics of the disclosed nanoparticles is unique because the gelling becomes time, temperature, and concentration dependent only after the nanoparticles are exposed to the chemical activators described in this document.

Unless otherwise defined, all technical and scientific terms used later in this document have the same meaning as commonly understood by one of ordinary skill in the art to which the present application belongs. Methods and materials are described later in this document for use in the present application; other, suitable methods and materials known in the art can also be used. The materials, methods, and examples are illustrative only and not intended to be limiting. All publications, patent applications, patents, sequences, database entries, and other references mentioned later in this document are incorporated by reference in their entirety. In case of conflict, the present specification, including definitions, will control.

Other features and advantages of the present application will be apparent from the following detailed description and figures, and from the claims.

### DESCRIPTION OF DRAWINGS

The patent or application file contains at least one color drawing executed in color. Copies of this patent application publication with color drawing(s) will be provided by the Patent and Trademark Office upon request and payment of the necessary fee.

FIG. 1 is a schematic representation of a silica nanoparticle coated with a positively charged cationic species.

FIGS. 2A and 2B are schemes showing the cationic species bound to silanol groups and silyloxy anions of an outer surface of the nanoparticle of FIG. 1.

FIG. 3 is a scheme showing modification of silica particles using cationic polymer poly(diallyl dimethyl ammonium chloride) (PDADMAC).

FIG. 4 is a schematic representation of a subterranean consolidated formation containing nanosilica particles coated with a cationic species (for example, PDADMAC).

FIG. 5 is an image showing a test tube containing a sand pack that was consolidated using nanosilica particles coated with a cationic species (for example, Clay Master™ 5C from Baker Hughes).

### DETAILED DESCRIPTION

Effective consolidation of incompetent subterranean formations is a formidable challenge. The most common methods of controlling the unwanted sand production involve: (1) filtering produced fluids through a pack of gravel retained by a screen, or (2) using consolidating fluids containing a resin and a curing agent, along with other chemicals to create a conducive environment for the resin curing reaction to occur. The gravel packing treatment is costly and typically involves the use of special tools and equipment. Furthermore, the gravel and the screen over a period of time may get plugged due to build-up of filtered material. Sand control by chemical consolidation involves injecting chemicals into the unconsolidated formation to provide grain-to-grain cementation. These conventional methods of sand consolidation by chemical reagents tend to have relatively uncontrollable setting times. A setting time that is too long can result in the fluids flowing into areas with greater permeability, which leads to an uneven treatment of the formation. A setting time that is too short can lead to premature curing of the resin, which leads to an unsuccessful treatment.

Accordingly, the present application provides particulate silica compositions and methods of using such compositions for effective consolidation of incompetent subterranean formations and control of loose sand in such formations, while retaining permeability of the subterranean formations to recoverable fluids. Embodiments of the silica compositions, and methods of making and using these compositions, are described later in this document.

### Definitions

For the terms “for example” and “such as,” and grammatical equivalents thereof, the phrase “and without limitation” can be understood to follow unless explicitly stated otherwise.

As used later in this document, the singular forms “a,” “an,” and “the” can include plural referents unless the context clearly dictates otherwise.

As used later in this document, the term “about” means “approximately” (for example, plus or minus approximately 10 percent (%) of the indicated value).

The term “substantially” as used later in this document refers to a majority of, or mostly, as in at least about 50%, 60%, 70%, 80%, 90%, 95%, 96%, 97%, 98%, 99%, 99.5%, 99.9%, 99.99%, or at least about 99.999% or more.

The term “particle” as used later can refer to a composition having a size from about 1 nanometer (nm) to about 1000 micrometers (μm). The term “microparticle” can refer to a particle having a size from about 1 μm to about 1000 μm. The term “nanoparticle” can refer to a particle having a size (for example, diameter of a spherical particle) from about 1 nm to about 1000 nm.

The term “particle size” (or “nanoparticle size” or “microparticle size”) as used later in this document can refer to the median size in a distribution of nanoparticles or microparticles (for example, on a volume or a number basis). The median size can be determined from the average linear dimension of individual nanoparticles, for example, the diameter of a spherical nanoparticle. Size may be determined by any number of methods in the art, including dynamic light scattering (DLS) and transmission electron microscopy (TEM) techniques. For measurements made using a laser diffraction instrument, or an equivalent method known in the art, the term “median particle size” can be defined as the median particle diameter as determined on an equivalent spherical particle volume basis. Where the term median is used, it can be understood to describe the particle size that divides the population in half such that 50% of the population is greater than or less than this size. The median particle size is often written as D50, D(0.5) or D[0.5], or similar.

“Polymer” as used later in this document, can be given its ordinary meaning as used in the art, that is, a molecular structure including one or more repeat units (monomers) connected by covalent bonds.

As used later in this document, the term “non-covalent” can refer to an interaction between two or more components where the bonds between the components are non-covalent bonds, meaning that no atom of one component shares a pair of electrons with an atom of another component. Non-covalent bonds can include weak bonds such as hydrogen bonds, electrostatic effects, x-effects, hydrophobic effects or Van der Waals forces.

As used later in this document, the term “dispersion” can refer to a system containing a dispersed phase within a continuous phase. In some embodiments, the dispersed phase and the continuous phase can be in a different state (for example, gas, solid or liquid). For example, in some embodiments, the dispersed phase is a solid while the continuous phase is a liquid. In some embodiments, the dispersed phase is a solid particulate material and the continuous phase is a liquid. In some embodiments, the dispersion is colloidal (for example, size of the particles of the dispersed phase is in the range from 1 nm to 1 μm).

As used later in this document, the terms “cation” or “cationic” can refer to a positively charged species where the atom (or atoms) bearing the positive charge in the cationic species contain lesser number of electrons than the number of protons in the atom's nucleus. In one example, the cation is a positively charged metal ion, such as Fe², Fe³⁺, or Al³⁺. In some examples, the cationic material is an organic molecule containing a positively charged nitrogen or phosphorus atom. In some examples, the cationic molecule is a polymer containing monomers with positively charged nitrogen or phosphorus atoms.

### Coated Silica Particles of the Present Disclosure

The present application provides, inter alia, a particulate silica material containing coated silica particles. In some embodiments, the present disclosure provides a silica particle coated with a cationic species.

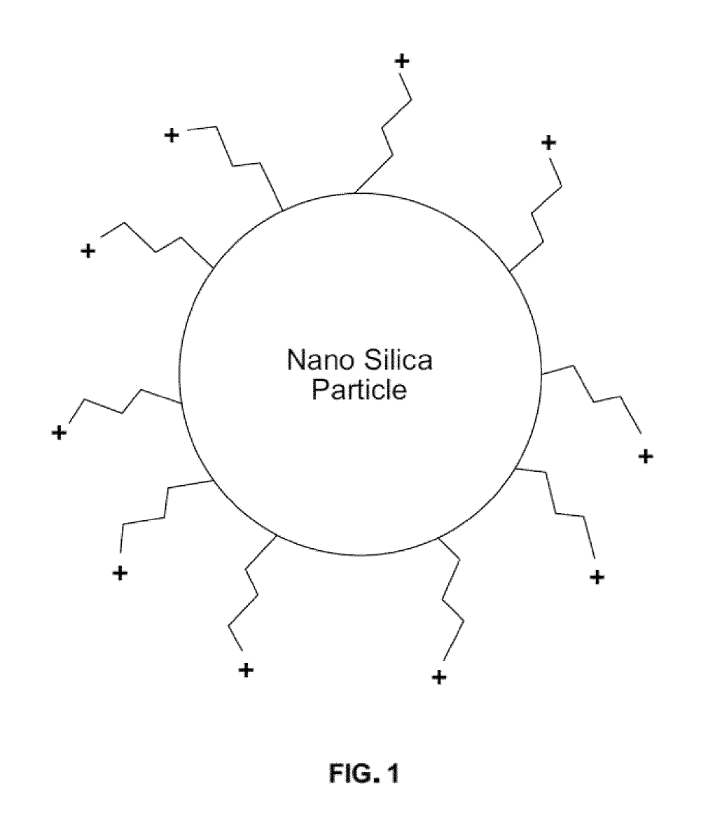

Referring to FIG. 1, a coated silica particle includes a core containing silicon dioxide (SiO₂) and an outer surface, and a cationic species (+) bound to the outer surface of the silica particle.

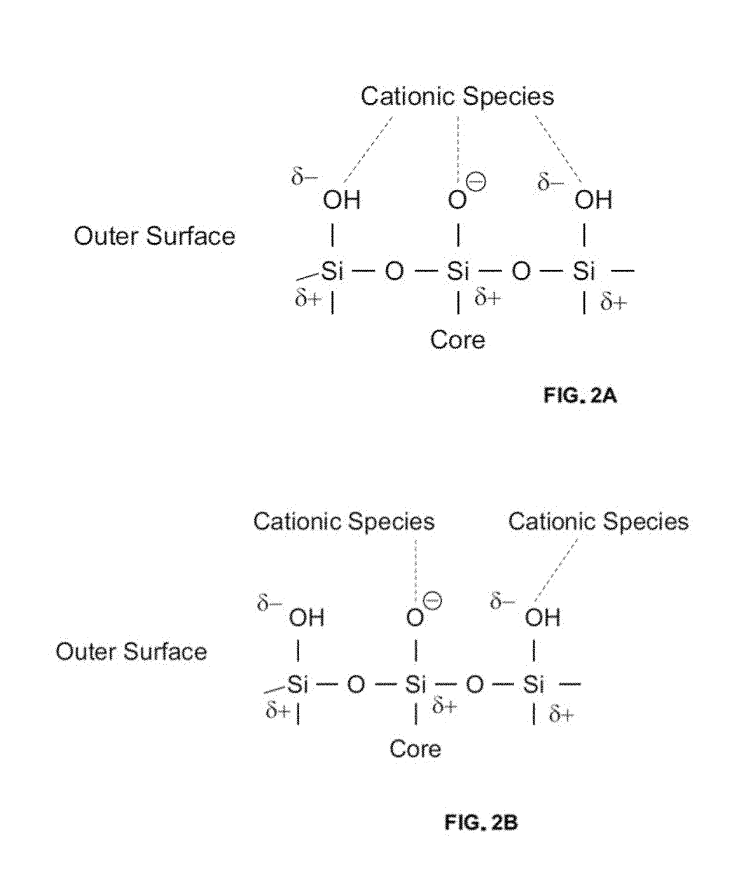

Referring to FIGS. 2A and 2B, shown is the outer surface of the particle of FIG. 1 that includes silanol groups (—Si—OH) and silyloxy anions (—SI—O—) non-covalently bound a cationic species.

In some embodiments, the cationic species is bound to the outer surface of the particle non-covalently. Still referring to FIGS. 2A and 2B, the dashed bonds between the cationic species and the silanol dipole/silyloxy anion represent the non-covalent bonding of the cationic species with the outer surface. In some embodiments, the non-covalent bonding between the cationic species and the outer surface of the silica particle includes hydrogen bonding, electrostatic interactions, Van der Waals forces, or any combinations thereof. In some embodiments, non-covalent binding between the cationic species and the outer surface of the silica particle includes an electrostatic interaction, such as an electrostatic attraction between the positively charged cationic species and the negatively charged outer surface of the silica particle. For example, as shown in FIGS. 2A and 2B, the outer surface of the silica particle is negatively charged due to the presence of the silyloxy anions and the Si—OH dipoles on the surface of the particle. These silyloxy anions and Si—OH groups attract the positively charged cationic species, such as cations of iron or aluminum, or the quaternary ammonium-containing polymers (for example, polyquaterniums). An example of a particulate silica material including the negatively charge silica particles is Cembinder® 50 (Akzo Nobel). In some embodiments, the particulate silica material contains cationic (positively charged) silica particles. An example of cationic silica is Levasil® 30-516P (Akzo Nobel).

In some embodiments, the coated silica particle is positively charged. This is possible because the net positive charge of the cationic species bound to the surface of the particle is in excess of the net negative charge of the outer surface of the particle. For example, a cationic species may include several positively charged atoms, and less than all (for example, one, two of three) of these atoms are non-covalently bound to the silyloxy anions and the Si—OH dipoles on the outer surface of the particle, while the remaining positively charged atoms of the cationic species are not directly bound to the surface and thus contribute to the overall net positive charge of the particle. One example of cationic species having more than one positively charged center is poly(diallyl dimethyl ammonium chloride) (PDADMAC, or polyquaternium-6) (CAS Registry No. 26062-79-3). Another example of such a cationic species is 1,2-ethanediaminium, N,N′-bis[2-[bis(2-hydroxyethyl)methylammonio]ethyl]-N,N′-bis(2-hydroxyethyl)-N,N′-dimethyl-, tetrachloride:

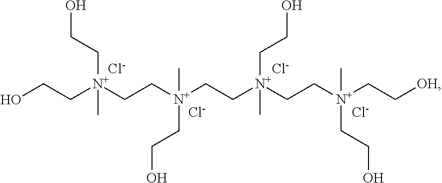 [SMILES: C[N+](CCO)(CCO)CC[N+](C)(CCO)CC[N+](C)(CCO)CC[N+](C)(CCO)CCO ; [Cl-] ; [Cl-] ; [Cl-] ; [Cl-]]

having four quaternary ammonium centers in the molecule. In some embodiments, all of the positively charged centers in the cationic species are non-covalently bound to the surface of the silica particle. In other embodiments, the cationic species comprises more than one positively charged center, and less than all (for example, one, two of three) of the positively charged centers in the cationic species are non-covalently bound to the surface of the silica particle. In some embodiments, less than all of the positively charged centers in the cationic species are non-covalently bound to the surface of the silica particle in at least about 10%, about 15%, about 20%, about 35%, about 50%, about 70%, about 90%, or about 99% of the total amount of the cationic species coating the silica particle, and in the remaining amount of the cationic species coating the silica particle all of the positively charged centers in the cationic species are non-covalently bound to the outer surface of the silica particle. In any of the earlier mentioned embodiments, the resultant particle, which contains a negatively charged material and the positively charged material, can have an overall net positive charge.

In some embodiments, the amount of the cationic species relative to the weight of the coated silica particle is in the range of about 0.5 weight percent (wt. %) to about 50 wt. %, about 1 wt. % to about 40 wt. %, about 1 wt. % to about 30 wt. %, about 1 wt. % to about 20 wt. %, about 1 wt. % to about 10 wt. %, about 1 wt. % to about 5 wt. %, about 5 wt. % to about 50 wt. %, about 5 wt. % to about 40 wt. %, about 5 wt. % to about 30 wt. %, about 5 wt. % to about 20 wt. %, or about 5 wt. % to about 10 wt. %. In some embodiments, 100% of the area of the outer surface of the silica particle is coated with the cationic species. In other embodiments, about 50%, about 60%, about 70%, about 80%, about 90%, or about 99% of the area of the outer surface of the silica particle is coated with the cationic species. In some embodiments, the outer surface of the silica particle is uniformly coated with the cationic species (for example, the amount of the cationic species coating the particle is equally distributed on the outer surface of the particle). In some embodiments, the particle is coated with two of more of the cationic species, for example, the coated silica particle comprises a metal ion (for example, Al³⁺) and PDADMAC non-covalently bound to the surface of the particle.

The core of the particle may comprise materials in addition to silicon dioxide. The core of the particle and the outer surface of the particle may contain a metal salt, a metal oxide, a metal hydroxide, silicon, carbon, silicon carbide, a silicon halide, or a similar material. In some embodiments, the particle contains from about 85 wt. % to about 99 wt. % of silicon dioxide. In some embodiments, the particle may also contain CaO, MgO, Na₂O, K₂O, Al₂O₃, Fe₂O₃, SiC, Si, C, SiF₄ or SiCl₄, and any combinations thereof. In some embodiments, the combined amount of these materials in the coated particle ranges from about 1 wt. % to about 15 wt. %. In some embodiments, the combined amount of materials other than silicon dioxide in the coated silica particle is in the range of about 1 wt. % to about 5 wt. %.

In some embodiments, the coated silica particle of the present disclosure is a microparticle. In such embodiments, the size (for example, diameter) of the microparticle is in the range of about 1 micrometer (μm) to about 1000 m, about 1 m to about 800 μm, about 1 m to about 500 m, about 1 m to about 250 m, about 1 m to about 100 μm, or about 10 m to about 50 μm. In some embodiments, the coated silica particle is a nanoparticle. In such embodiments, the size (for example, diameter) of the nanoparticle is in the range of about 1 nm to about 1000 nm, about 1 nm to about 900 nm, about 1 nm to about 800 nm, about 1 nm to about 700 nm, about 1 nm to about 600 nm, about 1 nm to about 500 nm, about 1 nm to about 400 nm, about 1 nm to about 300 nm, about 1 nm to about 200 nm, about 1 nm to about 150 nm, about 1 nm to about 100 nm, about 1 nm to about 50 nm, about 5 nm to about 100 nm, about 5 nm to about 50 nm, about 5 nm to about 25 nm, about 5 nm to about 20 nm, or about 5 nm to about 17 nm. In some embodiments, the coated silica particles form a composition and the median size of the particles in the composition is about 1 nm, about 5 nm, about 10 nm, about 20 nm, about 25 nm, about 50 nm, about 100 nm, or about 150 nm. The median size of the particles can be based on a volume average basis, which is the size of the particles at 50% in a cumulative particle distribution. In any of the earlier mentioned embodiments, the size of the particle can be an actual diameter of the particle or a diameter of an equivalent spherical particle.

In some embodiments, the shape of the coated silica particle is spherical, cylindrical, hemispherical, rod-shaped, or conical. In some embodiments, the particle is spherical or substantially spherical.

In some embodiments, the coated silica particles present within a population, for example in a composition, can be monodispersed, meaning that the particles of the population have substantially the same shape or size. For example, the particles can have a distribution such that no more than about 5% or about 10% of the particles have a diameter greater than about 10% greater than the average diameter of the particles, and in some cases, such that no more than about 8%, about 5%, about 3%, about 1%, about 0.3%, about 0.1%, about 0.03%, or about 0.01% have a diameter greater than about 10% greater than the average diameter of the particles. In some embodiments, the diameter of no more than 25% of the particles varies from the mean particle diameter by more than 150%, 100%, 75%, 50%, 25%, 20%, 10%, or 5% of the mean particle diameter. It is often desirable to produce a population of particles that is relatively uniform in terms of one or more of size, shape, and composition so that most of the particles have similar properties. For example, at least 80%, at least 90%, or at least 95% of the coated silica particles can have a diameter or greatest dimension that falls within 5%, 10%, or 20% of the average diameter or greatest dimension of the population. In some embodiments, a population of coated silica particles is homogeneous with respect to size, shape, mass, and composition.

In some embodiments, the present application provides a coated silica particle prepared by any one of the methods described later in this document.

In some embodiments, the silica particle is not pre-treated before coating with the cationic species. For example, the silica particle is not treated with a stabilizer before the silica particle is coated with the cationic species. In some embodiments, the silica particle is not treated with a neutral hydrophilic polymer before the silica particle is coated with the cationic species. In some embodiments, the silica particle is not treated with sodium citrate, gallic acid, sodium dodecyl sulfate, cetyl trimethyl ammonium bromide (CTAB), gelatin, D-sorbitol, polyvinylpyrrolidone (PVP), polyvinyl alcohol (PVA), poly(methylvinyl ether) (PMVE), or a combination thereof before the silica particle is coated with the cationic species. In some embodiments, the silica particle is not coated with polyvinylpyrrolidone (PVP).

In some embodiments, the silica particle is not porous (for example, not mesoporous). In some embodiments, the silica particle is porous (for example, mesoporous, having pores in diameter of about 1 nm to about 50 nm).

Cationic Species

In some embodiments, the cationic species comprises a cationic polymer. In some embodiments, the cationic polymer comprises at least one positively charged center (for example, atoms or groups of atoms), for example an ammonium cation, a phosphonium cation, or a guanidinium cation. In some embodiments, the cationic polymer comprises from about 10 to about 2,000 positively charged, cationic centers. In some embodiments, the cationic polymer comprises from about 100 to about 1,000, from about 100 to about 800, or from about 100 to about 400 cationic centers. In some embodiments, the cationic polymer has a volume-average or a number-average molecular weight in the range from about 500 Da to about 2,000,000 Da, about 1,000 Da to about 1,500,000 Da, about 1,000 Da to about 1,000,000 Da, about 1,000 Da to about 800,000 Da, about 1,000 Da to about 500,000 Da, from about 1,500 Da to about 500,000 Da, about 50,000 Da to about 400,000 Da, about 50,000 Da to about 350,000 Da, about 1,500 Da to about 100,000 Da, about 100,000 Da to about 350,000 Da, or about 200,000 Da to about 350,000 Da. In some embodiments, the cationic polymer is water soluble, for example, the aqueous solubility of the cationic polymer is in the range of about 5 wt. % to about 80 wt. %, about 10 wt. % to about 70 wt. %, about 10 wt. % to about 60 wt. %, about 10 wt. % to about 50 wt. %, or about 20 wt. % to about 40 wt. %. In some embodiments, the aqueous solubility of the cationic polymer is at least about 10 wt. %.

In some embodiments, the cationic species is a quaternary ammonium cationic polymer.

In some embodiments, the quaternary ammonium cationic polymer is PDADMAC. In some embodiments, the PDADMAC has the following structural repeating unit:

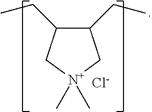

In some embodiments, the PDADMAC has the following structural formula:

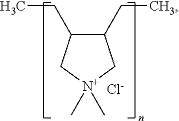

where n is an integer in the range of 10 to 5,000. The monomer diallyl dimethyl ammonium chloride (DADMAC) is formed by reacting two equivalents of allyl chloride with dimethylamine. PDADMAC is then synthesized by radical polymerization of DADMAC with a catalyst/activator of polymerization (for example, an organic peroxide such as t-BuOOH). The polymerization reaction may be conducted at elevated temperature (for example, 50-75 degrees Celsius (° C.)), for example, as shown in Scheme 1.

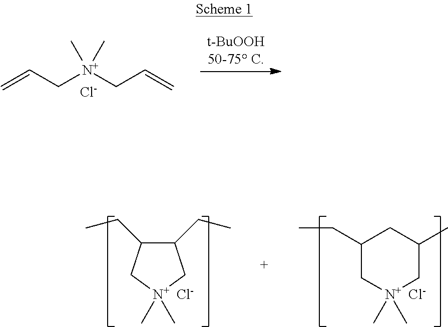

Referring to Scheme 1, two polymeric structural repeating units are possible when polymerizing DADMAC: N-substituted piperidine structure or N-substituted pyrrolidine structure, with the pyrrolidine structure being favored in the polymerization reaction. In some embodiments, the PDADMAC does not comprise the piperidine-containing repeating unit. In other embodiments, the PDADMAC comprises both the pyrrolidine-containing and the piperidine-containing repeating units.

In some embodiments, the cationic polymer is a co-polymer of DADMAC and acrylic acid, acrylamide, acrylonitrile, methacrylic acid, methacrylamide, cellulose, or cellulose derivative (for example, hydroxyethyl cellulose), or any combinations thereof (for example, the cationic polymer is a co-DADMAC). In some embodiments, the cationic polymer is a polyquaternium polymer. In some embodiments, the cationic polymer is selected from the group consisting of ethanol, 2,2′,2″-nitrilotris-, polymer with 1,4-dichloro-2-butene and N,N,N′,N′-tetramethyl-2-butene-1,4-diamine (polyquaternium-1), poly[bis(2-chloroethyl) ether-alt-1,3-bis[3-(dimethylamino)propyl]urea](polyquaternium-2), diallyldimethylammonium chloride (DADMAC)-hydroxyethyl cellulose copolymer (polyquaternium-4), copolymer of acrylamide and quaternized dimethylammoniumethyl methacrylate (polyquaternium-5), copolymer of acrylamide and diallyldimethylammonium chloride (P(AAm-co-DADMAC) or polyquaternium-7), copolymer of methyl and stearyl dimethylaminoethyl ester of methacrylic acid, quaternized with dimethylsulphate (polyquaternium-8), homopolymer of N,N-(dimethylamino)ethyl ester of methacrylic acid, quaternized with bromomethane (polyquaternium-9), quaternized hydroxyethyl cellulose (polyquaternium-10), copolymer of vinylpyrrolidone and quaternized dimethylaminoethyl methacrylate (polyquaternium-11), ethyl methacrylate/abietyl methacrylate/diethylaminoethyl methacrylate copolymer quaternized with dimethyl sulfate (polyquaternium-12), ethyl methacrylate/oleyl methacrylate/diethylaminoethyl methacrylate copolymer quaternized with dimethyl sulfate (polyquaternium-13), trimethylaminoethylmethacrylate homopolymer (polyquaternium-14), acrylamide-dimethylaminoethyl methacrylate methyl chloride copolymer (polyquaternium-15), copolymer of vinylpyrrolidone and quaternized vinylimidazole (polyquaternium-16), adipic acid, dimethylaminopropylamine and dichloroethylether copolymer (polyquaternium-17), azelanic acid, dimethylaminopropylamine and dichloroethylether copolymer (polyquaternium-18), copolymer of polyvinyl alcohol and 2,3-epoxypropylamine (polyquaternium-19), copolymer of polyvinyl octadecyl ether and 2,3-epoxypropylamine (polyquaternium-20), copolymer of acrylic acid and diallyldimethylammonium chloride (polyquaternium-22), quaternary ammonium salt of hydroxyethyl cellulose reacted with a lauryl dimethyl ammonium substituted epoxide (polyquaternium-24), block copolymer of polyquaternium-2 and polyquaternium-17 (polyquaternium-27), copolymer of vinylpyrrolidone and methacrylamidopropyl trimethylammonium (polyquaternium-28), chitosan modified with propylene oxide and quaternized with epichlorohydrin (polyquaternium-29), ethanaminium, N-(carboxymethyl)-N,N-dimethyl-2-[(2-methyl-1-oxo-2-propen-1-yl)oxy]-, inner salt, polymer with methyl 2-methyl-2-propenoate (polyquaternium-30), N,N-dimethylaminopropyl-N-acrylamidine quaternized with diethylsulfate bound to a block of polyacrylonitrile (polyquaternium-31), poly(acrylamide 2-methacryloxyethyltrimethyl ammonium chloride) (polyquaternium-32), copolymer of trimethylaminoethylacrylate salt and acrylamide (polyquaternium-33), copolymer of 1,3-dibromopropane and N,N-diethyl-N′,N′-dimethyl-1,3-propanediamine (polyquaternium-34), methosulphate of the copolymer of methacryloyloxyethyltrimethylammonium and of methacryloyloxyethyldimethylacetylammonium (polyquaternium-35), copolymer of N,N-dimethylaminoethylmethacrylate and butylmethacrylate, quaternized with dimethylsulphate (polyquaternium-36), poly(2-methacryloxyethyltrimethylammonium chloride) (polyquaternium-37), terpolymer of acrylic acid, acrylamide and diallyldimethylammonium chloride (polyquaternium-39), poly[oxyethylene(dimethylimino)ethylene (dimethylimino)ethylene dichloride] (polyquaternium-42), copolymer of acrylamide, acrylamidopropyltrimonium chloride, 2-amidopropylacrylamide sulfonate and dimethylaminopropylamine (polyquaternium-43), 3-methyl-1-vinylimidazolium methyl sulfate-N-vinylpyrroli done copolymer (polyquaternium-44), copolymer of (N-methyl-N-ethoxyglycine) methacrylate and N, N-dimethylaminoethylmethacrylate, quaternized with dimethyl sulphate (polyquaternium-45), terpolymer of vinylcaprolactam, vinylpyrrolidone, and quaternized vinylimidazole (polyquaternium-46), terpolymer of acrylic acid, methacrylamidopropyl trimethylammonium chloride, methyl acrylate (polyquaternium-47), and combinations thereof.

In some embodiments, the cationic polymer is poly(2-hydroxypropyl-1-N-dimethylammonium chloride) (CAS Registry No. 25988-97-0). In some aspects of these embodiments, the cationic polymer has the following structural repeating unit:

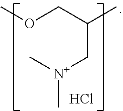

In some embodiments, the cationic polymer is poly(2-dimethylamino)ethyl methacrylate) methyl chloride quaternary salt (MADQUAT, CAS Registry No. 26161-33-1). In some aspects of these embodiments, the cationic polymer has the following structural repeating unit:

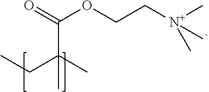

In some embodiments, the cationic polymer is optionally quaternized poly(N-dimethylaminopropyl)-methacrylamide (for example, methyl chloride quaternary salt). In some aspects of these embodiments, the cationic polymer has the following structural repeating unit:

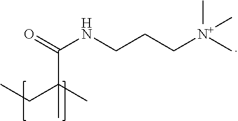

In some embodiments, the cationic polymer is poly(2-hydroxypropyl-1-1-N-dimethylammoniumchloride), poly[N-(dimethyl aminomethyl)]-acryl amide, or poly(2-vinylimidazolinium bisulfate).

In some embodiments, the cationic species comprises a positively charged compound with a molecular weight that is typically about 2,000 Da or less. In some aspects of these embodiments, the volume-average or number-average molecular weight of the cationic, positively charged compound is in the range from about 50 Da to about 2,000 Da, from about 100 Da to about 1,800 Da, from about 150 Da to about 1,600 Da, from about 100 Da to about 1,400 Da, from about 150 Da to about 1,200 Da, from about 100 Da to about 1,000 Da, from about 150 Da to about 800 Da, from about 150 Da to about 600 Da, from about 150 Da to about 500 Da, or from about 150 Da to about 400 Da. In some embodiments, the cationic compound comprises at least one positively charged center (for example, positively charged atom or groups of atoms), for example, an ammonium cation, a phosphonium cation, or a guanidinium cation. In some embodiments, the cationic compound comprises from 1 to 20 positively charged, cationic centers. For example, the cationic compound comprises 1, 2, 3, 4, 5, 6, 7, 8, 9, or 10 positively charged atoms or groups of atoms.

In some embodiments, the positively charged compound comprises a quaternary ammonium compound. In some embodiments, the quaternary ammonium compound is a quaternium (for example, a compound comprising a single quaternary ammonium center). For example, the quaternium compound comprises hexamethylenetetramine chloroallyl chloride (CAS Registry No. 4080-31-3) (quaternium-15) or dimethyldioctadecylammonium chloride (CAS Registry No. 61789-80-8) (quaternium-18).

In some embodiments, the quaternary ammonium compound comprises more than one quaternary ammonium center (for example, 2, 3, 4 or more of the quaternary ammonium cations in the compound). In some embodiments, the quaternary ammonium compound comprises 1,2-ethanediaminium, N,N′-bis[2-[bis(2-hydroxyethyl)methylammonio]ethyl]-N,N′-bis(2-hydroxyethyl)-N,N′-dimethyl-, tetrachloride (CAS Registry No. 138879-94-4) (Clay Master™ 5C) having the following chemical structure:

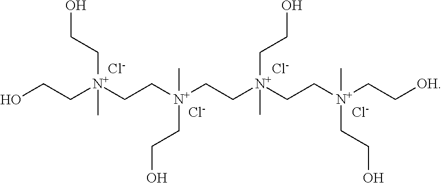 [SMILES: C[N+](CCO)(CCO)CC[N+](C)(CCO)CC[N+](C)(CCO)CC[N+](C)(CCO)CCO ; [Cl-] ; [Cl-] ; [Cl-] ; [Cl-]]

In some embodiments, the quaternary ammonium compound is selected from the group consisting of:

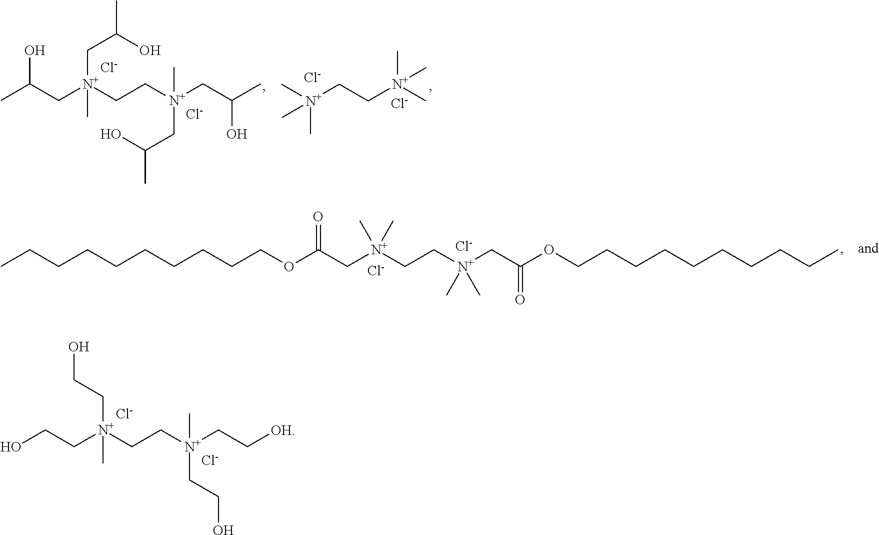

In some embodiments, the cationic species is a metal cation. In some embodiments, the metal cation comprises oxidation state of 2 or greater, for example, the metal cation is M²⁺, M³⁺, M⁴⁺, M⁵⁺ or M⁶⁺. In some examples, the metal cation comprises a metal selected from the group consisting of iron (Fe), aluminum (Al), calcium (Ca), magnesium (Mg), zinc (Zn), titanium (Ti), chromium (Cr), manganese (Mn), cobalt (Co), vanadium (V), nickel (Ni), copper (Cu), silver (Ag), and lead (Pb).

In some embodiments, the metal cation is selected from the group consisting of Fe²⁺, Fe³⁺, Al³⁺, Ca²⁺, Mg²⁺, Zn²⁺, Cr²⁺, Cr³⁺, Cr⁴⁺, Cr⁵⁺, Cr⁶⁺, V⁴⁺, V⁵⁺ and Ti⁴⁺. In some embodiments, the metal cation is Fe³⁺ or Al³⁺. In some embodiments, the metal cation forms a salt, or a solvate or a hydrate thereof. For example, the metal salt may be selected from the group consisting of FeCl₂, FeCl₃, FeF₃, FeSO₄, Fe₂(SO₄)₃, K₄Fe(CN)₆, Fe₄(P₂O₇)₃, FePO₄, Fe(ClO₄)₂, Fe₂(C₂O₄)₃, Fe(NO₃)₃, FeBr₃, AlBr₃, AlCl₃, AlF₃, Al(PO₃)₃, Al(NO₃)₃, AlNH₄(SO₄)₂, Al₂(SO₄)₃, KAl(SO₄)₂(alum), CaBr₂, CaCl₂, Ca(NO₃)₂, MgCl₂, and MgBr₂, and a solvate or a hydrate thereof. In other embodiments, the metal cation forms an oxide or a metal hydroxide, or a solvate or a hydrate thereof. For example, the metal oxide or hydroxide is selected from the group consisting of Fe₂O₃, FeO, Fe₂NiO₄, Fe₃O₄, Fe(OH)₂, Fe(OH)₃, FeOOH, alumosilicate (SiO₂)ₓ(Al₂O₃)_{y}, Al₂O₃, Al₂O₃/ZnO, ZnO, CaO, Mg(OH)₂, and Al(OH)₃, and a hydrate or solvate thereof. In some embodiments, the metal cation, or a compound comprising the metal cation (for example, metal salt, oxide or hydroxide), is water soluble. For example, in some embodiments, the aqueous solubility of the compound can range from about 5 wt. % to about 75 wt. % of the aqueous solution (for example, the aqueous solubility of the compound is about 10 wt. %, about 15 wt. %, about 20 wt. %, or about 30 wt. % of the aqueous solution).

### Compositions Comprising Coated Silica Particles of the Present Disclosure

The present disclosure also provides a composition comprising a coated silica particle as described earlier in this document. In some embodiments, the present disclosure provides a composition comprising a particulate material comprising the coated silica particle. For example, the particulate material may comprise silica which is not coated with the cationic species and at least one silica particle coated with the cationic species. In another example, the composition contains a plurality of the coated silica particles. In some embodiments, the composition comprises the particulate material comprising only silica particles coated with the cationic species and does not comprise any non-coated silica. In some embodiments, the composition comprises particulate material which comprises at least about 25%, about 35%, about 50%, about 60%, about 75%, about 90%, or about 99% by weight of the silica particles coated with the cationic species, with the remaining amount of particulate material being non-coated silica particles. In other embodiments, the composition comprises particulate material which comprises 100% by weight of the plurality of the coated silica particles.

In some embodiments, the amount of the particulate material in the composition is in the range of about 1 wt. % to about 90 wt. %, about 1 wt. % to about 80 wt. %, about 1 wt. % to about 70 wt. %, about 1 wt. % to about 60 wt. %, about 1 wt. % to about 50 wt. %, about 1 wt. % to about 40 wt. %, about 1 wt. % to about 35 wt. %, about 1 wt. % to about 25 wt. %, about 1 wt. % to about 20 wt. %, or about 1 wt. % to about 15 wt. %. In some embodiments, the amount of the particulate material in the composition is in the range of about 5 wt. % to about 50 wt. %, about 10 wt. % to about 50 wt. %, about 5 wt. % to about 40 wt. %, about 10 wt. % to about 35 wt. %, about 5 wt. % to about 35 wt. %, about 10 wt. % to about 25 wt. %, about 5 wt. % to about 15 wt. %, or about 15 wt. % to about 35 wt. %. In some embodiments, the amount of the particulate material in the composition is about 5 wt. %, about 7.5 wt. %, about 10 wt. %, about 12.5 wt. %, about 15 wt. %, about 20 wt. %, about 25 wt. %, about 30 wt. %, about 35 wt. %, about 40 wt. % about 50 wt. %, about 60 wt. %, or about 75 wt. %.

In some embodiments, the composition comprises a solvent, such as an aqueous solvent.

In some embodiments, the aqueous solvent comprises water. In some embodiments, the aqueous solvent also comprises a solvent other than water, for example, an alcohol such as methanol, ethanol, ethylene glycol, propylene glycol, polyethylene glycol, polypropylene glycol, glycerin, or mixtures thereof. In some embodiments, the aqueous solvent comprises water in an amount of about 40%, about 50%, about 60%, about 70%, about 80%, or about 90% or more by weight or by volume, with the remaining amount being a solvent other than water. In some embodiments, water is the only solvent in the composition.

In some embodiments, the composition comprises solvent in the range of about 10% to about 90%, about 10% to about 80%, about 10% to about 70%, about 10% to about 60%, about 10% to about 50%, about 50% to about 90%, or about 50% to about 75% by weight or by volume.

In some aspects of these embodiments, the solvent is water.

In some embodiments, the pH of the composition is from about 7 to about 12, from about 7.5 to about 12, from about 8 to about 12, from about 8 to about 11, from about 9 to about 12, or from about 9 to about 11. The pH of the composition is sufficient, for example, to ensure stability of the composition, to prevent agglomeration of the particulate material in the composition, and to prevent premature hardening of the composition. In some embodiments, the viscosity of the composition is in the range of about 1 centipoise (cP) to about 20 cP, about 1 cP to about 18 cP, about 1 cP to about 15 cP, about 1 cP to about 12 cP, about 1 cP to about 10 cP, about 1 cP to about 8 cP, about 1 cP to about 5 cP, about 5 cP to about 20 cP, about 5 cP to about 15 cP, about 5 cP to about 10 cP, or about 8 cP to about 10 cP. The viscosity of the composition is sufficient, for example, to ensure flowability of the composition, such that the composition may be conveniently and timely placed in a target zone of the subterranean formation using conventional wellbore equipment (for example, using coil tubing equipment).

In some embodiments, the particulate silica material and the solvent are the only ingredients in the composition. In other embodiments, the composition further comprises an activating agent. In some embodiments, the composition of the present disclosure is hardenable, that is, the composition forms a hard gel after a period of time (for example, the composition is a delayed gelling composition). In some embodiments, the composition is considered a hard gel when it is unable to flow. In some embodiments, the composition forms a hard gel after about 1 hour, about 2 hours, about 3 hours, about 4 hours, about 5 hours, about 6 hours, about 8 hours, about 10 hours, or about 12 hours or more after the formation of the composition. In some embodiments, the composition may form a hard gel without the activating agent. In other embodiments, the composition forms a hard gel due to the presence of the activating agent in the composition. Formation of the hard gel is possible because the silica particles (for example, the coated silica particles) aggregate forming a consolidated material. In some embodiments, the hardenable composition forms a hard gel when the pH of the composition changes, for example, to a pH less than 7. In some examples, the composition forms a hard gel at a pH of about 7, about 6.5, about 6, about 5.5, about 5, or about 4. In an acidic pH range, the silica particles aggregate to form a consolidated material. In some embodiments, the hardenable composition forms a hard gel at ambient temperature. In some embodiments, the hardenable composition forms a hard gel at a temperature less than the ambient temperature (for example, when the subterranean temperature is less than ambient temperature). In some embodiments, the hardenable composition forms a hard gel at elevated temperatures (for example, when the subterranean temperature is greater than ambient temperature). In some aspects of these embodiments, the hardenable composition forms a hard consolidated gel at a temperature in the range of about 50 degrees Fahrenheit (° F.) to about 500° F., about 50° F. to about 450° F., about 50° F. to about 400° F., about 50° F. to about 350° F., about 75° F. to about 500° F., about 75° F. to about 350° F., about 75° F. to about 250° F., about 150° F. to about 500° F., about 150° F. to about 350° F., or about 150° F. to about 250° F.

In some embodiments, the composition comprises an activating agent. Suitable examples of an activator include an alkali silicate, such as sodium silicate (Na-silicate) or potassium silicate (K-silicate). Na-silicate, as used in this disclosure, refers to compounds with the formula (Na₂SiO₂)_{f}O. In some embodiments, the Na-silicate is sodium metasilicate (Na₂SiO₃) or a polymeric silicate compound of formula (Na₂SiO₂)ₙO. Similarly, K-silicate, as used in this disclosure, refers to compounds with the formula (K₂SiO₂)ₙO. In some embodiments, the K-silicate is potassium metasilicate (K₂SiO₃) or a polymeric silicate compound of formula (K₂SiO₂)ₙO. In some embodiments, the activator facilitates the interaction between the cationic coating of the silica particle and the sand particle.

The amount of the activator in the composition is sufficient, for example, to activate the coated silica in the composition and to increase the rate of sand consolidation by the coated silica of the composition. In some embodiments, the activator is activated at increased temperature, such as from about 100° C. to about 200° C. In some embodiments, the activating agent facilitates hardening of the composition. In some embodiments, the composition comprises the activating agent in an amount in the range of about 0.1 wt. % to about 10 wt. %, about 0.1 wt. % to about 8 wt. %, about 0.1 wt. % to about 5 wt. %, about 0.25 wt. % to about 10 wt. %, about 0.25 wt. % to about 5 wt. %, about 0.25 wt. % to about 4 wt. %, about 0.5 wt. % to about 10 wt. %, about 0.5 wt. % to about 7.5 wt. %, about 0.5 wt. % to about 5 wt. %, about 1 wt. % to about 10 wt. %, about 1 wt. % to about 7.5 wt. %, about 2 wt. % to about 5 wt. %, or about 1 wt. % to about 5 wt. %. In some embodiments, the composition comprises about 0.1 wt. %, about 0.25 wt. %, about 0.5 wt. %, about 1 wt. %, about 2 wt. %, about 3 wt. %, about 4 wt. %, about 5 wt. %, about 7.5 wt. %, or about 10 wt. % of the activating agent.

In some embodiments, the activating agent is a pH modifier. For example, a pH modifier is a chemical compound that is capable of decreasing the pH of the composition. In one example, the pH modifier is an ester compound. An ester compound may be represented by the following chemical formula: R—C(═O)O—R′, where R and R′ are each independently an optionally substituted C₁₋₁₀ alkyl (for example, methyl, ethyl, propyl, isopropyl, butyl, pentyl, hexyl, and the like), or an optionally substituted C₆₋₁₀ aryl (for example, phenyl), C₃₋₇ cycloalkyl (for example, cyclohexyl) or C₃₋₇ heterocycloalkyl (for example, tetrahydrofuranyl). The optional substituents include OH, NH₂, SH, CN, halo, and similar groups. In some embodiments, the ester compound is an ester of an organic acid selected from the group consisting of formic acid, isobutyric acid, acetic acid, lactic acid, succinic acid, maleic acid, malic acid and combinations thereof. In some embodiments, the ester compound is selected from the group consisting of ethyl formate, methyl formate, triethyl orthoformate, trimethyl orthoformate, diethylene glycol diformate, ethylene glycol diformate, dipropylene glycol diformate, ethyl lactate, methyl lactate, and combinations thereof. In some embodiments, the ester compound is a polymeric material (for example, polylactide resin). In some embodiments, the ester compound hydrolyzes in the composition after a period of time after formation of the composition (for example, about 3 hours) to produce the corresponding acid (for example, formic acid or lactic acid), thereby decreasing the pH of the composition and activating the hardening of the composition. In some embodiments, the hydrolysis of the ester compound decreases the pH of the composition to about 6, about 5, or about 4. In some embodiments, the ester compound in the composition hydrolyzes at a subterranean temperature. In some embodiments, the ester compound hydrolyzes at a temperature from about 50° F. to about 500° F., about 50° F. to about 350° F., about 50° F. to about 250° F., about 75° F. to about 500° F., about 75° F. to about 350° F., about 75° F. to about 250° F., about 150° F. to about 500° F., or about 150° F. to about 250° F. In some embodiments, the composition comprises the ester compound in an amount from about 0.1 wt. % to about 10 wt. %, about 0.1 wt. % to about 5 wt. %, about 0.25 wt. % to about 10 wt. %, about 0.25 wt. % to about 4 wt. %, or from about 1 wt. % to about 5 wt. % of the composition.

In some embodiments, the composition comprises an activating agent that includes an ionic strength modifier. In some embodiments, the ionic strength modifier is an inorganic electrolyte such as an alkali or alkali-earth metal salt. In some aspects of these embodiments, the metal salt is selected from the group consisting of KCl, NaCl, NBr, NaBr, CaCl₂, CaBr₂, LiCl, KNO₃, Na₂(SO₄)₃, and combinations thereof. In some embodiments, the ionic strength modifier facilitates the aggregation of the silica particles, thereby facilitating the hardening and consolidation of the composition. In some embodiments, the composition comprises an ionic strength modifier in an amount from about 0.1 wt. % to about 10 wt. %, about 0.1 wt. % to about 5 wt. %, about 0.25 wt. % to about 10 wt. %, about 0.25 wt. % to about 5 wt. %, or from about 1 wt. % to about 5 wt. % of the composition.

In some embodiments, the composition comprises the pH modifying agent and the ionic strength modifying agent in any of the amounts disclosed earlier in this document. In some embodiments, the present application provides a composition comprising a coated silica particle prepared by any of the methods described later in this document.

### Making Coated Silica Particles and Compositions

The present application also provides a method of making a coated silica particle as described earlier in this document, comprising (i) obtaining a colloid dispersion comprising a solid silica particle and a solvent; (ii) obtaining a cationic species; and (iii) combining the colloid dispersion of step (i) with the cationic species of step (ii) to obtain the coated silica particle. In some embodiments, the colloid dispersion comprises a dispersed phase and a continuous phase, and the dispersed phase comprises the solid silica particle (for example, a plurality of solid silica particles), and the continuous phase comprises a solvent (for example, water).

The solid silica particle in the dispersion comprises a core and an outer surface. The core of the silica particle comprises SiO₂ and optionally other materials (for example, Al₂O₃, Si, C, SiC, SiCl₄, such as described earlier in this document for the coated silica particle). The outer surface of the silica particle comprises silanol groups and silyloxy anions (see, for example, FIGS. 2A and 2B). In some embodiments, the outer surface of the solid silica particle is negatively charged. For example, the silanol dipoles and the silyloxy anions on the outer surface of the silica particle contribute to the net negative charge of the outer surface. The colloid dispersion comprises a particulate silica material (for example, a plurality of the solid silica particles). In some embodiments, the silica particles are monodisperse (for example, have a uniform size, shape and composition, such as described earlier for the coated silica particles). In some embodiments, the particulate silica material is the only constituent of the disperse phase of the dispersion. In other embodiments, the disperse phase of the dispersion comprises a material other than particulate silica (for example, sand, clay, or cement). The solvent in the continuous phase of the dispersion may comprise a solvent other than water (such as an alcohol or other solvent as described earlier in this document). In some embodiments, water is the only solvent in the dispersion. In some embodiments, the particulate silica in the dispersion has a surface area per unit mass of dispersion in the range of about 10 square meter per grams (m²/g) to about 2,000 m²/g, about 20 m²/g to about 1,500 m²/g, or about 30 m²/g to about 1,000 m²/g. In some embodiments, the solid silica particles in the dispersion are microparticles or nanoparticles (for example, as described earlier for the coated silica particles). In some embodiments, the solid silica particle is a nanoparticle having a size (for example, diameter) in the range of about 1 nm to about 1,000 nm, about 1 nm to about 500 nm, about 1 nm to about 150 nm, about 1 nm to about 50 nm, about 4 nm to about 50 nm, or about 5 nm to about 17 nm. In some embodiments, the amount of the particulate silica material in the dispersion is in the range of about 1 wt. % to about 90 wt. %, about 5 wt. % to about 75 wt. %, about 10 wt. % to about 75 wt. %, about 5 wt. % to about 50 wt. %, or about 10 wt. % to about 50 wt. %. In some embodiments, the amount of the particulate silica material in the dispersion is about 5 wt. %, about 10 wt. %, about 15 wt. %, about 20 wt. %, about 35 wt. %, or about 50 wt. %. Cembinder® 50 supplied by Akzo Nobel is a non-limiting example of the colloid silica dispersion.

In some embodiments, the cationic species may be obtained as a solution in a solvent, for example, a solution of PDADMAC in water or a mixture of water and an alcohol as described earlier in this document. In some embodiments, the cationic species may be obtained as a mixture (for example, a solution) in water. In some embodiments, the concentration of the cationic species in the solution is from about 5 wt. % to about 75 wt. %, about 10 wt. % to about 75 wt. %, about 5 wt. % to about 50 wt. %, or about 10 wt. % to about 50 wt. %. In some embodiments, the concentration of the cationic species in the mixture with the solvent is about 5 wt. %, about 10 wt. %, about 15 wt. %, about 20 wt. %, about 35 wt. %, or about 50 wt. %. In some embodiments, the amount of the cationic species obtained in step (ii) is in the range of about 0.01 wt. % to about 5 wt. %, about 0.05 wt. % to about 5 wt. %, about 0.1 wt. % to about 5 wt. %, about 0.25 wt. % to about 5 wt. %, about 0.5 wt. % to about 5 wt. %, about 1 wt. % to about 5 wt. %, about 0.1 wt. % to about 4 wt. %, or about 0.1 wt. % to about 2 wt. % relative the amount of colloidal dispersion comprising the solid particulate silica.

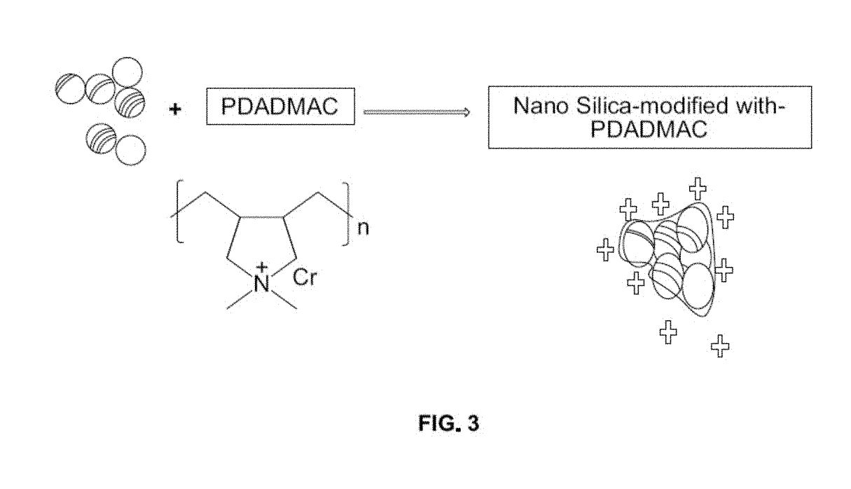

In some embodiments, the combining comprises adding the cationic species obtained in step (ii) to the colloid dispersion obtained in step (i). In other embodiments, the combining comprises adding the colloidal dispersion obtained in step (i) to the cationic species obtained in step (ii). In some embodiments, the combining comprises evenly distributing the cationic species in the colloidal dispersion. Referring to FIG. 3, following the combining of the cationic species (for example, PDADMAC) with the colloid dispersion, the cationic species coats the solid silica particles in the dispersion, for example by non-covalently bonding to the silanol dipoles and silyloxy anions on the outer surface of the silica particles, to form the coated silica particle as described earlier in this document. The positively charged cationic centers in the cationic species facilitate the binding due to the electrostatic attraction between the positively charged atoms and the negatively charged silanol groups and silyloxy anions on the outer surface of the silica particles.

In some embodiments, the combining comprises continuously stirring the mixture of the silica dispersion and the cationic species (for example, the reaction mixture). The stirring may comprise agitation, swirling or shaking, or any combinations thereof. The stirring of the reaction mixture may be performed using any conventional equipment and protocols known in the art, for example, by using conventional blender units. The stirring of the reaction mixture is typically performed for an amount of time that is sufficient to produce the coated silica particle as described earlier in this document (for example, an amount of time from about 1 minute (min) to about 30 min, about 1 min to about 20 min, about 1 min to about 15 min, about 1 min to about 10 min, or about 1 min to about 5 min).

In some embodiments, the method comprises a step of obtaining an activator. In some embodiments, the activator may be obtained as a solution in a solvent, for example a solution of Na-silicate of K-silicate in water or a mixture of water and an alcohol. In some embodiments, the method comprises a step of combining the activator with the colloid dispersion of solid silica particles obtained in step (i). In some embodiments, the method comprises a step of combining the activator with the cationic species obtained in step (ii). In some embodiments, the method comprises a step of combining the activator with the coated silica particle obtained in step (iii).

In some embodiments, the method further comprises removing a solvent (for example, water) from the reaction mixture to obtain the solid silica particle coated with the cationic species (for example, a powdered particulate material comprising the coated particles). The solvent may be removed by any conventional technique such as rotary evaporation or lyophilization.

In some embodiments, the present application provides a method of making a composition comprising a coated silica particle described earlier (for example, hardenable, delayed-gelling composition). In some embodiments, the method of making the composition comprises combining a solid silica particle coated with a cationic species (for example, a particulate material comprising plurality of coated particles) and a solvent (for example, water or water/alcohol mixture). In other embodiments, any of the methods described earlier for making a coated silica particle may be used to prepare the hardenable delayed-gelling composition comprising the coated particle. In some aspects of these embodiments, the method of making the composition comprises (i) obtaining a colloid dispersion comprising a solid silica particle and a solvent; (ii) obtaining a cationic species; and (iii) combining the colloid dispersion of step (i) with the cationic species of step (ii) to obtain the hardenable composition comprising the coated silica particle (for example, a particulate material comprising the coated silica particle or a plurality of the coated silica particles). The non-limiting embodiments of such a method are described earlier in this document for the methods of preparation of the coated silica particles. In some embodiments, the method of making the hardenable composition comprises adding at least one activating agent to the composition/dispersion/reaction mixture. For example, any one of the activating agents as described earlier in this document can be added to the composition in any of the amounts described earlier. The activating agent may be added to the composition/dispersion/reaction mixture in a form of a solution. For example, when the activating agent is an ionic strength modifier such as NaCl, the concentration of the ionic strength modifier in the solution can be in the range of about 1 weight-to-volume percent (% w/v) to about 30% w/v, about 5% w/v to about 25% w/v, or about 5 wt. % to about 15 wt. %. In some embodiments, the method comprises adding at least two activating agents to the composition (for example, an ionic strength modifier and a pH modifier). The components of the composition may be mixed at the location of use (for example, near a wellbore) using fracturing conventional blender units.

### Methods of Using Coated Particles and Compositions for Consolidating Subterranean Formations

In some embodiments, the present application provides a method of consolidating an incompetent subterranean formation comprising contacting the incompetent formation with the composition comprising a coated silica particle as described earlier in this document. In some embodiments, the contacting provides a consolidated mass of subterranean particles. Incompetent, unconsolidated subterranean formations contain loosely cemented particles that may be carried away from the formation when a recoverable fluid flows through the formation. The formation can lose its structural support, become eroded, and collapse, leading to damage of the wellbore and the equipment. The loose subterranean particles can include grains of sand, clay or rock, such as sandstone, gravel, limestone, quartz, zeolite, siltstone or shale, or any combinations thereof. Most frequently, incompetent subterranean formations contain loosely consolidated grains of sand. Contacting the unconsolidated sand particles of the formation with the present hardenable delayed-gelling composition can cement the sand grains together at the contact points. This creates a strong consolidated matrix that consolidates the formation.

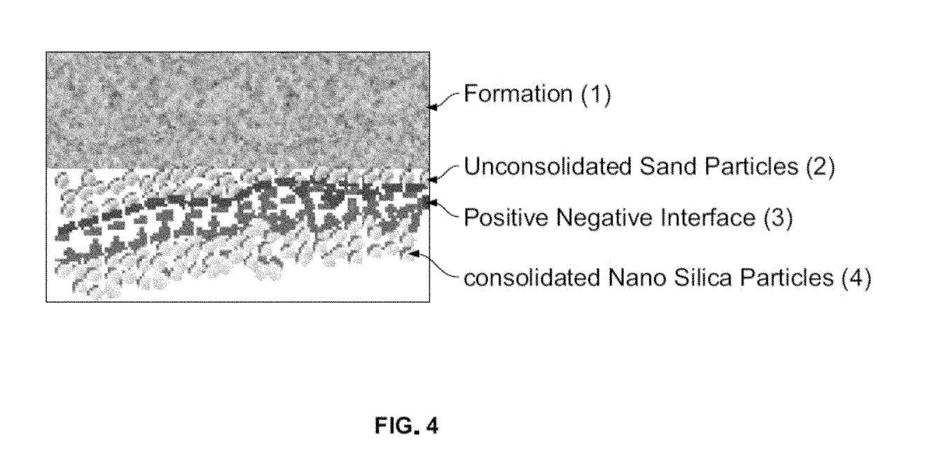

The surface of the unconsolidated sand grains (or particles) has a net negative charge. The positively charged silica particles coated with the cationic species can self-assemble over the unconsolidated formation sand particles due to electrostatic attraction, to form a layer of consolidating material. Referring to FIG. 4, upon hardening of the composition in a formation (1) at the positive negative interface (3), a thin layer of a hard gel that contains the consolidated silica nanoparticles (4) is formed around the unconsolidated sand particles (2). This hard gel can cement the sand grains together while also maintaining a desired porosity through the treated consolidated material to facilitate production of recoverable fluids, such as hydrocarbons. The similar positive charge of the coated silica particles leads to repulsion between the coated particles that helps to maintain the low viscosity of the composition (for example, a viscosity of about 5 cP to about 10 cP) and prevent the premature hardening of the composition, for example, while being delivered in a coil tubing. The composition is referred to as a sand control pill when it is delivered to a target zone. The charge repulsion between positively charged individual cationic species and the coated silica particles would prevent any unwanted agglomeration of the coated silica. Furthermore, the similar charge repulsive forces ensure a monolayer coating of surface of the sand grains in the unconsolidated formation. The positively charged silica particles, having an affinity for the negatively charged sand grains in the formation, produce a thin layer coating on the surface of the negatively charged grains of the unconsolidated formation.

In some embodiments, the incompetent formation is penetrated by a wellbore. The hardenable composition may be delivered to the target incompetent zone in need of treatment, for example, using conventional coil tubing equipment. In some embodiments, the formation bears recoverable fluids, for example, water or hydrocarbons such as petroleum or natural gas. In some embodiments, when the incompetent formation is consolidated using the composition and methods described earlier in this document, the resultant consolidated formation remains permeable to the withdrawn fluids. In some embodiments, the method further comprises producing the fluid (for example, oil) from the consolidated formation. The production of the fluid from the wellbore can be achieved using any conventional equipment generally known in the art.

In some embodiments, the consolidated formation comprising the consolidated mass of subterranean particles can withstand a pressure load of greater than about 700 pounds-force (lbf), about 800 lbf, about 900 lbf, about 100 lbf, or about 1,200 lbf. In some embodiments, the consolidated mass of particles may hold a load pressure in the range of about 700 lbf to about 1000 lbf. In some embodiments, an amount of the hardenable composition delivered in a single sand control pill may be in the range of about 100 gallons to about 5,000 gallons, about 200 gallons to about 4,500 gallons, about 300 gallons to about 4,000 gallons, about 400 gallons to about 4,000 gallons, or about 500 gallons to about 3750 gallons. The amount of the composition that may be delivered to the target zone depends on a variety of factors, such as reservoir thickness (for example, a formation vertical thickness of about 20 feet (ft.) to about 150 ft.), as determined by a skilled petroleum engineer. In some embodiments, the volume of hardenable composition per every 20 feet of formation thickness can be about 500 gallons.

### EXAMPLES

### Example 1—Preparation of Coated Silica Nanoparticles

5 milliliters (mL) of Cembinder® 50 (Akzo Nobel) colloidal nanosilica was added to a beaker.

TABLE 1
The Cembinder ® 50 colloidal product was supplied
by Akzo Nobel and had the following characteristics:

| | |
|---|---|
| SiO₂ (wt %) | 15% |
| Na₂O (wt %) | 0.4% |
| pH | ~10 |
| Viscosity (cP) | 3.0 |
| Density in grams per cubic centimeter (g/cm³) | 1.1 |
| Average Size (nm) | 5 |

To the beaker containing the Cembinder® 50, 0.5 mL of 25% NaCl aqueous solution was introduced under constant stirring. The resultant mixture was mixed for 5 minutes. Following this, the nanosilica was modified with a cationic modifier. The cationic modifier used was Clay Master™ 5C (Baker Hughes), which is a complex polyamine salt supplied by Baker Hughes. Clay Master™ 5C is a polyamine with the chemical name 1,2-ethanediaminium, N,N′-bis[2-[bis(2-hydroxyethyl)methyl ammonio]ethyl]-N,N′-bis(2-hydroxyethyl)-N,N′-dimethyl-, tetrachloride. (Commercially available formulation from Baker Hughes is a 30 wt. % to 60 wt. % solution of the active component). The nanosilica modification was carried out in situ by adding 0.1 mL of Clay Master™ 5C to the mixture of nanosilica and NaCl. (2 v/v % of Clay Master™ 5C relative to the amount of the nanosilica and NaCl solution).

### Example 2—Using Coated Silica Nanoparticles for Sand Consolidation

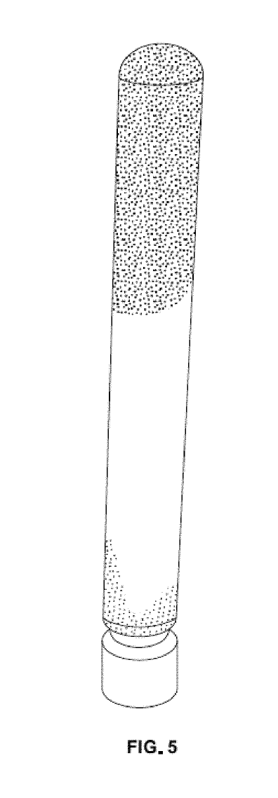

After stirring the solution prepared in Example 1 for another 5 minutes, 5 grams of 100 mesh sand was slowly added to the solution under continuous stirring. This resulted in a uniform coating of the sand with the cationic modified nanosilica. The nanosilica coated sand was packed in a test tube and put in an oven at 100° C. for 24 hours for curing. After 24 hours the sand was found to be completely consolidated as seen in FIG. 5. The consolidated sand particles had strength to withstand an applied pressure load of between 700 to 1000 lbf. The compressive strength was determined by a uniaxial stress load frame to measure the unconfined compressive strength (UCS) of the consolidated sand particles. A cylindrical shaped consolidated core with dimension of 1″ in diameter by 2″ long was used. The load is applied on the two flat ends with no confining around the circumference. The stress at which the consolidated core breaks is the UCS of the consolidated sand particles (for example, a pressure load of between 700 to 1000 lbf).

To check whether the consolidated sand pack was permeable, same formulation as explained previously was packed in a 10 mL syringe as follows. Lose sand particles were packed in a syringe. This was followed by injection of the treatment solution. The treated syringes were kept in an oven at a temperature of 100° C. for 24 hours. After designated time period the syringes were removed to obtain consolidated sand packs. 2 mL of 2% NaCl aqueous solution was injected through the consolidated sand pack. It was observed that the sand pack absorbed the NaCl solution.

### Example 3—Gelling of Cationic Nanosilica

34.5 mL of Levasil® 30-516P nanosilica (Akzo Nobel) was added to a beaker. Levasil® 30-516P nanosilica carries an overall positive surface charge.

TABLE 2
The Levasil ® 30-516P colloidal product was supplied
by Akzo Nobel and had the following characteristics:

| | |
|---|---|
| SiO₂ (wt %) | 25 |
| Specific surface area in grams per square meter (m²/g) | 160 |
| Surface area (m²/g) | 200 |
| pH | 3.8 |
| Viscosity (cP at 25° C.) | <5 |
| Density (g/cm³) | 1.2 |

To this beaker, 0.5 ml of 25% NaCl aqueous solution was introduced under constant stirring. The resultant mixture was mixed for 5 minutes. Following this, 5 mL of Clay Master™ 5C, was added. The mixture was stirred for 5 minutes. After stirring, 40 grams of 1:1 mixture of 20:40 mesh and 100 mesh sand was added slowly to the solution under continuous stirring. This resulted in a uniformly coated sand with cationic species. The coated sand was packed in a test tube and put in an oven at 100° C. The test tube was observed after every hour for curing of the coated sand. The sand was considered to be completely cured when it did not flow even after inverting the test tube.

In another experiment 37 mL of Levasil® 30-516P was added to a beaker. To this beaker, 0.5 ml of 25% NaCl aqueous solution was introduced under constant stirring. The resultant mixture was mixed for 5 minutes. Following this, 2.5 mL of Clay Master™ 5C, was added. The mixture was stirred for 5 minutes. After stirring, 40 grams of 1:1 mixture of 20:40 mesh and 100 mesh sand was added slowly to the solution under continuous stirring. The coated sand was packed in a test tube and put in an oven at 100° C. The test tube was observed after every hour for curing of the coated sand.

For both experiments previously described, it was observed that the sand was completely cured after 24 hours.

### Example 4—Gelling of Nanosilica with Alternate Activator

Na-silicate and K-silicate were respectively used as alternate activators for Levasil® 30-516P nanosilica. Various formulations using these activators were studied. The results for curing time using these formulations are depicted in Table 3.

The following mixing procedure was used to mix the formulations: Levasil® 30-516P nanosilica was added to a beaker. To this beaker, Na-silicate or K-silicate solutions were introduced drop-wise under constant stirring. The resultant mixture was mixed for 5 minutes. Following this, Clay Master™ 5C, was added. The mixture was stirred for 5 minutes. After stirring, 40 grams of 1:1 mixture of 20:40 mesh and 100 mesh sand was added slowly to the solution under continuous stirring. The coated sand was packed in a test tube and put in an oven at 100° C. The test tube was observed after every hour for curing of the coated sand.

TABLE 3
Curing time for Levasil ® 30-516P nanosilica using Na-silicate,
K-silicate and Clay Master ™ 5C

| System | | | | | | |
|---|---|---|---|---|---|---|
| | Clay | Na- | K- | pH | | Curing- |
| Levasil ® | Master ™ | silicate | silicate | (25 | | time |
| (mL) | (mL) | (mL) | (mL) | ° C.) | T(° F.) | (hours) |
| 33 | 5 | — | 2 | 3.1 | 20 | 5 |
| 36 | 3 | — | 1 | 2.9 | 200 | 16 |
| 33 | 5 | 2 | — | 3.3 | 200 | 3 |
| 36 | 3 | 1 | — | 2.9 | 200 | 16 |

To check whether the cured sand pack was permeable, the formulations were packed in a 10 mL syringe as described in Example 2. After treating the sand pack with the treatment fluids, the syringes were kept in an oven at a temperature of 100° C. for 24 hours. After a designated time period, the syringes were removed to obtain consolidated sand packs. A 2% NaCl aqueous solution was continuously injected through the consolidated sand packs. It was observed that the NaCl solution passed through the sand pack without any resistance, indicating that the sand packs are permeable.

### CERTAIN EMBODIMENTS

### Embodiment 1

A coated silica particle, the particle comprising a cationic species non-covalently bound to an outer surface of the particle.

### Embodiment 2

The particle of embodiment 1, wherein the particle comprises a nanoparticle.

### Embodiment 3

The particle of embodiment 1 or 2, wherein the outer surface of the particle is negatively charged.

### Embodiment 4

The particle of embodiment 1 or 2, wherein the outer surface of the particle is positively charged.

### Embodiment 5

The particle of any one of embodiments 2-4, wherein the nanoparticle comprises a diameter from about 1 nm to about 500 nm.

### Embodiment 6

The particle any one of embodiments 2-4, wherein the nanoparticle comprises a diameter from about 1 nm to about 150 nm.

### Embodiment 7

The particle of any one of embodiments 2-4, wherein the nanoparticle comprises a diameter from about 5 nm to about 50 nm.

### Embodiment 8

The particle of any one of embodiments 2-4, wherein the nanoparticle comprises a diameter from about 5 nm to about 17 nm.

### Embodiment 9

The particle of any one of embodiments 1-8, wherein the cationic species comprises a metal cation.

### Embodiment 10

The particle of embodiment 9, wherein the metal cation comprises an oxidation state of 2 or greater.

### Embodiment 11

The particle of embodiment 9 or embodiment 10, wherein the metal cation comprises aluminum or iron.

### Embodiment 12

The particle of any one of embodiment 9-11, wherein the metal cation forms a salt or an oxide selected from the group consisting of Al₂O₃, Al₂(SO₄)₃, KAl(SO₄)₂, FeCl₃ and Fe₂(SO₄)₃, and a hydrate or a solvate thereof.

### Embodiment 13

The particle of any one of embodiments 1-8, wherein the cationic species comprises a cationic polymer.

### Embodiment 14

The particle of embodiment 13, wherein the cationic polymer is selected from the group consisting of poly(2-hydroxypropyl-1-N-dimethylammonium chloride), poly(2-hydroxypropyl-1-1-N-dimethylammoniumchloride), poly[N-(dimethylaminomethyl)]-acrylamide, poly(2-vinylimidazolinium bisulfate), poly(diallyldimethylammoniumchloride), poly(N-dimethylaminopropyl)-methacrylamide, and combinations thereof.

### Embodiment 15

The particle of embodiment 13, wherein the cationic polymer comprises poly(diallyldimethylammoniumchloride).

### Embodiment 16

The particle of any one of embodiments 13-15, wherein the molecular weight of the cationic polymer ranges from about 1,000 Da to about 1,000,000 Da.

### Embodiment 17

The particle of any one of embodiments 13-15, wherein the molecular weight of the cationic polymer ranges from about 1,500 Da to about 500,000 Da.

### Embodiment 18

The particle of any one of embodiments 13-15, wherein the molecular weight of the cationic polymer ranges from about 1,500 Da to about 100,000 Da.

### Embodiment 19

The particle of any one of embodiments 13-18, wherein the cationic polymer is water soluble.

### Embodiment

The particle of any one of embodiments 1-8, wherein the cationic species comprises a quaternary ammonium compound.

### Embodiment 21

The particle of embodiment 20, wherein the quaternary ammonium compound comprises 1,2-ethanediaminium, N,N′-bis[2-[bis(2-hydroxyethyl)methyl ammonio]ethyl]-N,N′-bis(2-hydroxyethyl)-N,N′-dimethyl-, tetrachloride.

### Embodiment 22

The particle of any one of embodiments 1-21, wherein an amount of the cationic species relative to the weight of the silica particle ranges from about 5 wt. % to about 20 wt. %.

### Embodiment 23

The particle of any one of embodiments 1-22, wherein the coated particle comprises a net positive charge.

### Embodiment 24

The particle of any one of embodiments 1-23, wherein the non-covalent binding between the cationic species and the outer surface of the silica particle comprises an electrostatic interaction.

### Embodiment 25

The particle of embodiment 24, wherein the electrostatic interaction comprises attraction between the negatively charged outer surface of the silica particle and the positively charged cationic species.

### Embodiment 26

The particle of embodiment 25, wherein the electrostatic interaction comprises attraction between silanol groups or silyloxy anions on the outer surface of the silica particle and the positively charged cationic species.

### Embodiment 27

A method of making a coated silica particle comprising a cationic species non-covalently bound to an outer surface of the silica particle, the method comprising:

(i) obtaining a colloid dispersion comprising a solid silica particle in a dispersed phase and a solvent in a continuous phase;

(ii) obtaining a cationic species; and

(iii) combining the colloid dispersion of step (i) with the cationic species of step (ii) to obtain a coated silica particle.

### Embodiment 28

The method of embodiment 27, wherein the solid silica particle is a nanoparticle.

### Embodiment 29

The method of embodiment 28, wherein the nanoparticle comprises a diameter from about 1 nm to about 500 nm.

### Embodiment 30

The method of embodiment 28, wherein the nanoparticle comprises a diameter from about 1 nm to about 150 nm.

### Embodiment 31

The method of embodiment 28, wherein the nanoparticle comprises a diameter from about 5 nm to about 50 nm.

### Embodiment 32

The method of embodiment 28, wherein the nanoparticle comprises a diameter from about 5 nm to about 17 nm.

### Embodiment 33

The method of any one of embodiments 27-32, wherein the solvent in the continuous phase of the colloid dispersion comprises water.

### Embodiment 34

The method of any one of embodiments 27-33, wherein an amount of the dispersed phase in the colloid dispersion ranges from about 5 wt. % to about 50 wt. %.

### Embodiment 35

The method of any one of embodiments 27-33, wherein an amount of the dispersed phase in the colloid dispersion is about 15 wt. %.

### Embodiment 36

The method of any one of embodiments 27-35, further comprising adding a solution of an inorganic salt to the colloid dispersion.

### Embodiment 37

The method of embodiment 36, wherein the inorganic salt comprises NaCl.

### Embodiment 38

The method of embodiment 36 or embodiment 37, wherein a concentration of the inorganic salt in the solution ranges from about 1% w/v to about 30% w/v.

### Embodiment 39

The method of any one of embodiments 34-36, wherein an amount of the solution of an inorganic salt ranges from about 5 wt. % to about 15 wt. % relative to the amount of the colloidal dispersion.

### Embodiment 40

The method of any one of embodiments 27-39, wherein the cationic species comprises a metal cation.

### Embodiment 41

The method of embodiment 40, wherein the metal cation comprises an oxidation state of 2 or greater.

### Embodiment 42

The method of embodiment 40 or embodiment 41, wherein the metal cation comprises aluminum or iron.

### Embodiment 43

The method of any one of embodiment 40-42 wherein the metal cation forms a salt or an oxide selected from the group consisting of Al₂O₃, Al₂(SO₄)₃, KAl(SO₄)₂, FeCl₃ and Fe₂(SO₄)₃, and a hydrate or a solvate thereof.

### Embodiment 44

The method of any one of embodiments 27-39, wherein the cationic species comprises a cationic polymer.

### Embodiment 45

The method of embodiment 44, wherein the cationic polymer is selected from the group consisting of poly(2-hydroxypropyl-1-N-dimethylammonium chloride), poly(2-hydroxypropyl-1-1-N-dimethylammoniumchloride), poly[N-(dimethylaminomethyl)]-acrylamide, poly(2-vinylimidazolinium bisulfate), poly(diallyldimethylammoniumchloride), poly(N-dimethylaminopropyl)-methacrylamide, and combinations thereof.

### Embodiment 46

The method of embodiment 44, wherein the cationic polymer comprises poly(diallyldimethylammoniumchloride).

### Embodiment 47

The method of any one of embodiments 44-46, wherein a molecular weight of the cationic polymer ranges from about 1,000 Da to about 1,000,000 Da.

### Embodiment 48

The method of any one of embodiments 44-46, wherein a molecular weight of the cationic polymer is from about 1,500 Da to about 500,000 Da.

### Embodiment 49

The method of any one of embodiments 44-46, wherein a molecular weight of the cationic polymer is from about 1,500 Da to about 100,000 Da.

### Embodiment 50

The method of any one of embodiments 44-49, wherein the cationic polymer is water soluble.

### Embodiment 51

The method of any one of embodiments 27-39, wherein the cationic species comprises a quaternary ammonium compound.

### Embodiment 52

The method of embodiment 51, wherein the quaternary ammonium compound comprises 1,2-ethanediaminium, N,N′-bis[2-[bis(2-hydroxyethyl)methylammonio]ethyl]-N,N′-bis(2-hydroxyethyl)-N,N′-dimethyl-, tetrachloride.

### Embodiment 53

The method of any one of embodiments 27-52, wherein the cationic species is in a form of a solution.

### Embodiment 54

The method of embodiment 53, wherein the solution comprises an aqueous solution.

### Embodiment 55

The method of embodiment 53 or embodiment 54, wherein a concentration of the cationic species in the solution ranges from about 10 wt. % to about 50 wt. %.

### Embodiment 56

The method of any one of embodiments 27-55, wherein an amount of the cationic species ranges from about 0.1 wt. % to about 2 wt. % relative to an amount of the colloidal dispersion.

### Embodiment 57

The method of any one of embodiments 27-56, wherein the combining comprises adding the cationic species to the colloid dispersion.

### Embodiment 58

The method of any one of embodiments 27-57, wherein the combining is followed by continuously stirring the reaction mixture for an amount of time sufficient to obtain the coated silica particle.

### Embodiment 59

The method of embodiment 58, wherein the amount of time ranges from about 1 minute to about 15 minutes.

### Embodiment 60

The method of any one of embodiments 27-59, wherein the combining comprises a non-covalent binding of the cationic species to the outer surface of the silica particle.

### Embodiment 61

The method of embodiment 60, wherein the non-covalent binding between the cationic species and the outer surface of the silica particle comprises an electrostatic interaction.

### Embodiment 62

The method of embodiment 61, wherein the electrostatic interaction comprises attraction between the negatively charged outer surface of the silica particle and the positively charged cationic species.

### Embodiment 63

The method of embodiment 62, wherein the electrostatic interaction comprises attraction between silanol groups or silyloxy anions on the outer surface of the silica particle and the positively charged cationic species.

### Embodiment 64

The method of any one of embodiments 27-63, further comprising combining an activator with the colloid dispersion comprising the solid silica particle.

### Embodiment 65

The method of embodiment 64, wherein the activator is an alkali silicate.

### Embodiment 66

The method of embodiment 65, wherein the alkali silicate is selected from Na-silicate and K-silicate.

### Embodiment 67

A coated silica particle prepared by a method of any one of embodiments 27-66.

### Embodiment 68

A hardenable delayed-gelling composition comprising a particulate material comprising a coated silica particle of any one of embodiments 1-26 and 67.

### Embodiment 69

The composition of embodiment 68, wherein the amount of the particulate material in the composition is from about 10 wt. % to about 50 wt. %.

### Embodiment 70

The composition of embodiment 68, wherein an amount of the particulate material in the composition is about 15 wt. %.

### Embodiment 71

The composition of any one of embodiments 68-70, further comprising a solvent.

### Embodiment 72

The composition of embodiment 71, wherein the solvent comprises water.

### Embodiment 73

The composition of embodiment 72, wherein the composition comprises from about 50 wt. % to about 90 wt. % water.

### Embodiment 74

The composition of any one of embodiments 68-73, wherein a pH of the composition ranges from about 9 to about 11.

### Embodiment 75

The composition of any one of embodiments 68-74, wherein a viscosity of the composition ranges from about 5 cP to about 10 cP.

### Embodiment 76

The composition of any one of embodiments 68-75, further comprising an activating agent.

### Embodiment 77

The composition of embodiment 76, wherein the activating agent comprises a pH modifier.

### Embodiment 78

The composition of embodiment 77, wherein the pH modifier comprises an ester compound.

### Embodiment 79

The composition of embodiment 78, wherein the ester compound is selected from the group consisting of a formate ester, a lactate ester, and a polylactide resin.

### Embodiment 80

The composition of embodiment 78, wherein the ester compound is selected from the group consisting of diethylene glycol diformate and ethyl lactate.

### Embodiment 81

The composition of any one of embodiments 78-80, wherein the ester compound hydrolyzes to produce an acid compound.

### Embodiment 82

The composition of embodiment 81, wherein the hydrolysis of the ester compound occurs at a temperature ranging from about 75° F. to about 350° F.

### Embodiment 83

The composition of embodiment 81, wherein the hydrolysis of the ester compound occurs at a temperature ranging from about 150° F. to about 250° F.

### Embodiment 84

The composition of any one of embodiments 81-83, wherein the hydrolysis of the ester compound results in reduction of a pH of the composition to less than about 5.

### Embodiment 85

The composition any one of embodiments 76-84, wherein the amount of the pH modifier in the composition ranges from about 0.25 wt. % to about 4 wt. %.

### Embodiment 86

The composition of embodiment 76, further comprising an ionic strength modifier.

### Embodiment 87

The composition of embodiment 86, wherein the ionic strength modifier comprises an inorganic electrolyte.

### Embodiment 88

The composition of embodiment 87, wherein the inorganic electrolyte is selected from the group consisting of KCl, NaCl and NaBr.

### Embodiment 89

The composition of any one of embodiments 86-88, wherein an amount of the ionic strength modifier in the composition ranges from about 1 wt. % to about 5 wt. %.

### Embodiment 90

The composition of embodiment 76, wherein the activating agent comprises alkali silicate.

### Embodiment 91

The method of embodiment 90, wherein the alkali silicate is selected from Na-silicate and K-silicate.

### Embodiment 92

The composition of any one of embodiments 76-91, wherein the activating agent is configured to facilitate hardening of the composition.

### Embodiment 93

The composition of any one of embodiments 68-92, wherein the composition is adapted to form a hard consolidated gel three hours or more after formation of the composition.

### Embodiment 94

The composition of embodiment 93, wherein the composition is adapted to form a hard consolidated gel at a temperature ranging from about 75° F. to about 350° F.

### Embodiment 95

The composition of embodiment 93, wherein the composition is adapted to form a hard consolidated gel at a temperature ranging from about 150° F. to about 250° F.

### Embodiment 96

A method of consolidating an incompetent subterranean formation, the method comprising contacting an incompetent formation with a hardenable delayed-gelling composition of any one of embodiments 68-95 to obtain a consolidated mass of subterranean particles.

### Embodiment 97

The method of embodiment 96, wherein the contacting further comprises absorbing the hardenable delayed-gelling composition on a surface of unconsolidated subterranean particles.

### Embodiment 98

The method of embodiment 97, wherein hardening of the composition comprises cementing the subterranean particles as a layer of hard gel on the unconsolidated subterranean particles.

### Embodiment 99

The method of any one of embodiments 96-98, wherein the subterranean particles comprises sand grains.

### Embodiment 100

The method of any one of embodiments 96-99, wherein the consolidated mass of subterranean particles is permeable to fluids.

### Embodiment 101

The method of embodiment 100, wherein the consolidated mass of subterranean particles has strength to hold a pressure load of about 700 lbf or greater.

### Embodiment 102

The method of embodiment 101, wherein the consolidated mass of subterranean particles has strength to hold a pressure load from about 700 lbf to about 1000 lbf.

### Embodiment 103

The method of any one of embodiments 96-102, wherein the incompetent subterranean formation is penetrated by a wellbore.

### Embodiment 104

The method of embodiment 103, wherein the contacting comprises delivering the hardenable delayed-gelling composition to the incompetent subterranean formation using a coil tubing equipment.

### Embodiment 105

The method of any one of embodiments 96-104, wherein the incompetent subterranean formation comprises a hydrocarbon-bearing formation.

### Embodiment 106

The method of embodiment 105, wherein the hydrocarbon comprises petroleum.

### Embodiment 107

The method of embodiment 106, wherein the method further comprises producing petroleum from the consolidated formation.

### OTHER EMBODIMENTS

It is to be understood that while the present application has been described in conjunction with the detailed description thereof, the foregoing description is intended to illustrate and not limit the scope of the present application, which is defined by the scope of the appended claims. Other aspects, advantages, and modifications are within the scope of the following claims.

1. A method of consolidating an incompetent subterranean formation, the method comprising contacting an incompetent formation with a hardenable delayed-gelling composition comprising a coated silica particle comprising a cationic species non-covalently bound to an outer surface of the particle, to obtain a consolidated mass of subterranean particles.

2. The method of claim 1, wherein the silica particle is a nanoparticle comprising a diameter from about 5 nm to about 50 nm.

3. The method of claim 1, wherein the cationic species is a cationic polymer selected from the group consisting of poly(2-hydroxypropyl-1-N-dimethylammonium chloride), poly(2-hydroxypropyl-1-1-N-dimethylammoniumchloride), poly[N-(dimethylaminomethyl)]-acrylamide, poly(2-vinylimidazolinium bisulfate), poly(diallyldimethylammoniumchloride), poly(N-dimethylaminopropyl)-methacrylamide, and combinations thereof.

4. (canceled)

5. The method of claim 3, wherein an amount of the cationic polymer relative to the weight of the silica particles in the composition ranges from about 5 wt. % to about 20 wt. %.

6. The method of claim 5, wherein the non-covalent binding between the cationic polymer and the outer surface of the silica particle comprises an electrostatic interaction between negatively charged silanol groups or silyloxy anions on the outer surface of the silica particle and the positively charged cationic polymer.

7. The method of claim 6, wherein the hardenable delayed-gelling composition comprises water and an amount of the particulate material in the composition is from about 10 wt. % to about 50 wt. %.

8. The method of claim 7, wherein the pH of the hardenable delayed-gelling composition ranges from about 9 to about 11.

9. The method of claim 1, wherein the cationic species comprises a metal cation comprising aluminum or iron.

10. The method of claim 9, wherein the metal cation forms a salt or an oxide selected from the group consisting of Al₂O₃, Al₂(SO₄)₃, KAl(SO₄)₂, FeCl₃ and Fe₂(SO₄)₃, and a hydrate or a solvate thereof.

11. The method of claim 10, wherein the pH of the hardenable delayed-gelling composition ranges from about 3 to about 5.

12. The method of claim 1, wherein the hardenable delayed-gelling composition comprises an activating agent configured to facilitate hardening of the composition.

13. The method of claim 12, wherein the activating agent is a pH modifier comprising an ester compound, wherein the ester compound hydrolyzes at a temperature ranging from about 75° F. to about 350° F. to produce an acid compound.

14. The method of claim 13, wherein an amount of the pH modifier in the composition ranges from about 0.25 wt. % to about 4 wt. %.

15. The method of claim 14, wherein the ester compound is selected from the group consisting of a formate ester, a lactate ester, and a polylactide resin.

16. The method of claim 12, wherein the activating agent is an ionic strength modifier comprising an inorganic electrolyte, wherein an amount of the ionic strength modifier in the composition ranges from about 1 wt. % to about 5 wt. %.

17-18. (canceled)

19. The method of claim 1, wherein the contacting of the incompetent formation with the hardenable delayed-gelling composition comprises adsorbing the hardenable delayed-gelling composition on a surface of unconsolidated subterranean particles.

20-23. (canceled)

24. A method of consolidating an incompetent subterranean formation, the method comprising contacting an incompetent formation with a hardenable delayed-gelling composition comprising a coated silica particle comprising a cationic polymer non-covalently bound to an outer surface of the particle and an activating agent configured to facilitate hardening of the composition, to obtain a consolidated mass of subterranean particles.

25-26. (canceled)

27. The method of claim 24, wherein the activating agent comprises a polyamine.

28. The method of claim 27, wherein the polyamine comprises 1,2-ethanediaminium, N1, N2-bis[2-[bis(2-hydroxyethyl)methylammonio]ethyl]-N1,N2-bis(2-hydroxyethyl)-N1,N2-dimethyl-, chloride.

29. The method of claim 24, wherein the activating agent comprises an alkali silicate and a polyamine.
